(19) United States
(12) Patent Application Publication
(10) Pub. No.: US 2006/0039045 A1
(43) Pub. Date: Feb. 23, 2006

(54) Document processing device, document processing method, and storage medium recording program therefor

(75) Inventors: Naoko Sato, Ebina-shi (JP); Masatoshi Tagawa, Ebina-shi (JP); Michihiro Tamune, Ashigarakami-gun (JP); Atsushi Itoh, Ashigarakami-gun (JP); Kiyoshi Tashiro, Kawasaki-shi (JP); Hiroshi Masuichi, Ashigarakami-gun (JP); Shaoming Liu, Ashigarakami-gun (JP); Kyosuke Ishikawa, Minato-ku (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 11/080,621

(22) Filed: Mar. 16, 2005

(30) Foreign Application Priority Data
Aug. 19, 2004 (JP) 2004-239479

(51) Int. Cl. H04N 1/387

(52) U.S. Cl. 358/538; 358/453

(57) ABSTRACT

The present invention provides a document processing device including: an inputting unit that inputs page image data corresponding to images of pages of a document; an extracting unit that analyzes the page image data input by the inputting unit, specifies the content of each item contained in the document corresponding to that page image data, and extracts item data, the item data being character strings expressing that content; a generating unit that links the item data extracted by the extracting unit and generates name data, the name data being a character string expressing a name to be attached to the document; and a writing unit that associates the name data generated by the generating unit with the page image data input by the inputting unit and writes the name data and the page image data to a memory.

This application claims priority under 35 U.S.C. §119 of Japanese Patent Application No. 2004-239479 filed on Aug. 19, 2004, the entire content of which is hereby incorporated by reference.

### BACKGROUND OF THE INVENTION

1. Field of the Invention

The present invention relates to technologies for digitizing and accumulating paper documents, in particular technologies for digitizing and accumulating paper documents that attach a unique name to each paper document.

2. Description of Related Art

Paper documents (hereafter also referred to as “documents”) are an outstanding medium for transmitting and recording information, but entail problems including requiring spaces such as archives for storage. Furthermore, when information is recorded in paper documents and stored, if the information recorded in those paper documents is later needed, the paper documents in which the desired information is recorded must be found among a large number of paper documents stored in archives and similar places. In other words, seen from the point of view of operational efficiency, recording and storing information in paper documents is not desirable.

On this background, it has become common to digitize and store paper documents. Specifically, it has become common to read images corresponding to pages in a paper document using a scanner or the like, convert image data (hereafter, “page image data”) corresponding to the images for each paper document in files, and store those files in storage devices such as hard disks.

However, when writing the files to a device such as a hard disk, it is necessary to attach a unique name (hereafter also referred to as a “filename”) to each file, and this is generally done as follows. The filename can determined based on information specified by the user beforehand (e.g., information entered using a keyboard or the like or information entered by hand), they can be generated using a default character string plus serial numbers, as in “Scan1, Scan2, . . . ”, or using character strings expressing the date or time of scanning.

However, if the user is forced to specify filenames beforehand, this presents the problem of placing a very large burden on the user when batch-digitizing a large number of paper documents. On the other hand, if filenames are generated automatically using serial numbers, dates, and so on, this problem will not arise even when digitizing a large number of paper documents. However, since filenames attached in this manner do not express the content, for example, of the paper documents to which the files correspond, the tremendous inconvenience will be required of checking the content of each file at a later date when searching for a file containing required information.

The present invention has been made in view of the above circumstances and provides a technology that allows attachment of names to paper documents in correspondence with their content and without placing a burden on a user, when digitizing and saving paper documents.

### SUMMARY OF THE INVENTION

To address the problems stated above, the present invention provides a document processing device including: an inputting unit that inputs page image data corresponding to images of pages of a document; an extracting unit that analyzes the page image data input by the inputting unit, specifies the content of each item contained in the document corresponding to that page image data, and extracts item data, the item data being character strings expressing that content; a generating unit that links the item data extracted by the extracting unit and generates name data, the name data being a character string expressing a name to be attached to the document; and a writing unit that associates the name data generated by the generating unit with the page image data input by the inputting unit and writes the name data and the page image data to a memory.

With this document processing device, page image data corresponding to images of pages in a document and name data corresponding to the content of the document are associated with each other and written to the storage device.

### BRIEF DESCRIPTION OF THE DRAWINGS

Embodiments of the present invention will be described in detail based on the following figures, wherein:

FIG. 1 is a diagram showing an example of an overall configuration of a document digitizing system provided with a document processing device 110 according to a first embodiment of the present invention;

FIG. 2 is a diagram showing an example of a hardware configuration of the document processing device 110;

FIG. 3 is a flowchart showing a flow of a paper document digitizing process which is performed by a control unit 200 of the document processing device 110 in accordance with paper document digitizing software;

FIG. 4 is a table showing a relationship between item data extracted by the document processing device 110 and name data generated based on the item data;

FIG. 5 is a flowchart showing a flow of a paper document digitizing process which is performed by the control unit 200 of the document processing device according to a second variation example;

FIG. 6 is a view showing an example of a directory configuration in a nonvolatile storage unit 220b of the document processing device according to the second variation example;

FIG. 7 shows an example of an importance level table stored in the nonvolatile storage unit 220b of the document processing device according to a third variation example;

FIG. 8 is a flowchart showing a flow of a paper document digitizing process which is performed by the control unit 200 of the document processing device according to the third variation example;

FIG. 9 shows an example of an item list table stored in the nonvolatile storage unit 220b of the document processing device according to a fourth variation;

FIG. 10 is a flowchart showing a flow of a paper document digitizing process which is performed by the control unit 200 of the document processing device according to the fourth variation example.

### DETAILED DESCRIPTION OF THE INVENTION

Below is a description of embodiments according to the present invention, with reference to the drawings.

A: Configuration

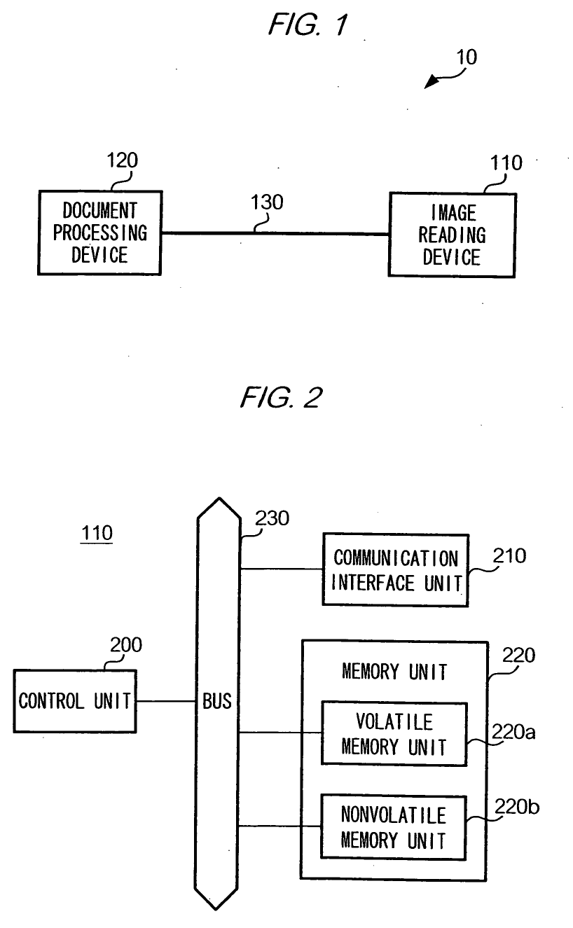

FIG. 1 is a block diagram showing an example of a configuration of a document digitizing system 10 provided with a document processing device 110 according to a first embodiment of the present invention. An image reading device 120 in FIG. 1 is, for example, a scanner device provided with an ADF (Auto Document Feeder) or other type of automatic paper feeding mechanism, which reads, one page at a time, paper documents set in the ADF, and passes page image data corresponding to read images to the document processing device 110 via a communication line 130, such as a LAN (Local Area Network). Note that while in the present embodiment a case is described wherein the communication line 130 is a LAN, this may of course encompass WANs (Wide Area Networks), the Internet, and so on. Note also that while in the present embodiment a case is described wherein the document processing device 110 and the image reading device 120 are configured as individual hardware components, both may of course be configured as a single hardware component. In such an embodiment, the communication line 130 is an internal bus connecting the document processing device 110 and the image reading device 120 within the single hardware component.

The document processing device 110 in FIG. 1, which converts page image data passed from the image reading device 120 into files, attaches unique names to the files, and stores and accumulates the files, is provided with a configuration shown in FIG. 2. As shown in FIG. 2, the document processing device 110 includes a control unit 200, a communications interface unit 210, a memory unit 220, and a bus 230 which intermediates transmission and reception of data among these constituent parts.

The control unit 200 is, for example, a CPU (Central Processing Unit), which controls various units of the document processing device 110 by executing various software programs stored in the memory unit 220 described below. The communications interface unit 210 is connected to the image reading device 120 via the communication line 130, and receives page image data sent from the image reading device 120 via the communication line 130 and passes it to control unit 200. In other words, the communications interface unit 210 functions as an inputting unit for inputting page image data sent from the image reading device 120.

As shown in FIG. 2, the memory unit 220 includes a volatile memory unit 220a and a nonvolatile memory unit 220b. The volatile memory unit 220a is, for example, a RAM (Random Access Memory), and is used as a work area by the control unit 200 which operates in accordance with various software programs described below, functioning as a buffer which temporarily accumulates page image data passed from the communications interface unit 210. In contrast, the nonvolatile memory unit 220b is, for example, a hard disk, which converts the page image data into files, and stores and accumulates those files. Note that in the present embodiment a case is described wherein page image data input to the document processing device 110 is written to a memory unit provided in the document processing device 110, but it is also possible to convert the page image data, document by document, into files and write those files onto a storage device separate from the document processing device 110. Software which allows the control unit 200 to realize functions specific to the document processing device 110 in accordance with the present embodiment is stored in the nonvolatile memory unit 220b. Examples of the software stored in the nonvolatile memory unit 220b include operating system (“OS”) software which allows the control unit 200 to realize an OS and paper document digitizing software. Paper document digitizing software is software which generates name data expressing names attached to paper documents including pages corresponding to the page image data based on content of the page image data, associates the name data and the page image data, and makes the control unit 200 write this to the nonvolatile memory unit 200b. Below is a description of functions provided to the control unit 200 by execution of these software programs.

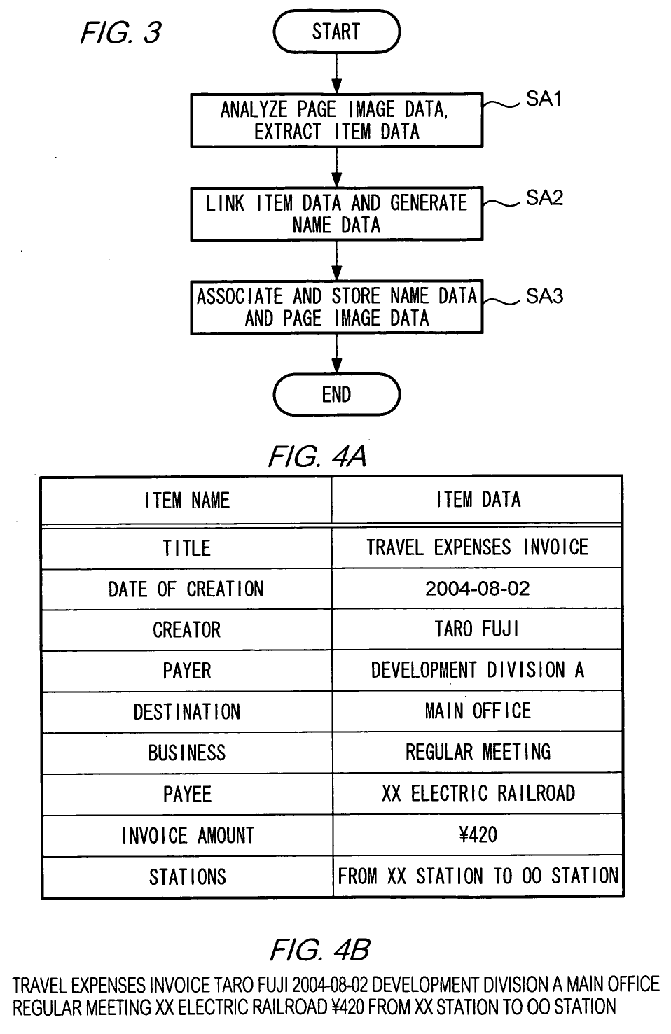

When an electric power source (not illustrated) of the document processing device 110 is turned on, the control unit 200 first reads the OS software from the nonvolatile memory unit 220b. When operating according to the OS software and realizing an OS, the control unit 200 is provided with functions to control various units of the document processing device 110, functions to read other software from the nonvolatile memory unit 220b and execute it, and so on. According to the present embodiment, as soon as execution of the OS software is complete and the OS is being realized, the control unit 200 reads the paper document digitizing software from the nonvolatile memory unit 220b and executes it. FIG. 3 is a flowchart showing a flow of a paper document digitizing process which is performed by the control unit 200 operating in accordance with the paper document digitizing software. As shown in FIG. 3, the three functions described below are provided to the control unit 200 operating in accordance with the paper document digitizing software.

First is an extracting function for analyzing content of page image data which has been input via the communications interface unit 210 and accumulated in the volatile memory unit 220a, and extracting item data in the form of character strings expressing the content for each item listed in the pages corresponding to that page image data. Second is a generating function for linking the item data extracted by the extracting function and generating name data in the form of a character string expressing a name to be attached to the page image data. Third is a storing function for associating the name data generated by the generating function with the page image data and storing the name data and the page image data by writing them to the nonvolatile memory unit 220b.

As described above, a hardware configuration of the document processing device according to the present embodiment is identical to that of ordinary computer devices, and operation of the control unit 200 in accordance with various software programs stored in the nonvolatile memory unit 220b realizes functions specific to the document processing device according to the present invention. Accordingly, while in the present embodiment a case has been described wherein software modules realize functions specific to the document processing device according to the present invention, it is also possible to configure the document processing device according to the present invention using hardware modules which provide these functions. Specifically, it is possible to configure the document processing device according to the present invention by using hardware modules to realize an inputting unit, into which page image data is input from the image reading device 120, an extracting unit which provides the extracting function, a generating unit which provides the generating function, and a writing unit which associates name data generated by the generating unit with page image data input to the inputting unit and writes this to a hard disk or other storage device, and to combine the hardware modules to work in cooperation as shown in the flowchart shown in FIG. 3.

B: Operation

Next follows a description of those operations that illustrate the characteristic features of the document processing device 110, with reference to the drawings.

First, when a user sets a paper document on the ADF of the image reading device 120 and performs a predetermined operation (e.g., pressing a start button provided on an operating unit of the image reading device 120), images corresponding to pages in the paper document are read by the image reading device 120 and page image data corresponding to the images of the pages is sent to the document processing device 110 from the image reading device 120 via the communication line 130.

When the page image data is input through the communications interface unit 210, the control unit 200 of the document processing device 110 stores the page image data by writing it to the volatile memory unit 220a in the order in which it was input, until the page image data for all pages in the paper document has been input. Once the page image data for all pages has been input, the control unit 200 digitizes the paper documents by generating name data expressing a name to be attached to the paper document, associating the name data with the page image data accumulated in the volatile memory unit 220a, and writing this to the nonvolatile memory unit 220b in accordance with the flowchart shown in FIG. 3. Below is a description of the operations performed by the control unit 200, with reference to FIG. 3.

FIG. 3 is a flowchart showing a flow of a paper document digitizing process which is performed by the control unit 200. As shown in FIG. 3, the control unit 200 analyzes the content of all the page image data accumulated in the volatile memory unit 220a by performing a language analysis, a layout analysis, or the like, and then extracts item data expressing the content for each item contained in the pages corresponding to the page image data (step SA1). Below is a description of a case wherein page image data (hereafter referred to as “page image data A”), which corresponds to one page of a paper document for claiming traveling expenses (hereafter referred to as “document A”), is input and item data shown in FIG. 4A is extracted.

Next, the control unit 200 links the item data extracted in step SA1 and generates name data expressing a name to be attached to document A (step SA2). According to the present embodiment, for the document A, the name data shown in FIG. 4B is generated in step SA2, since the item data shown in FIG. 4A has been extracted in step SA1.

Next, the control unit 200 associates the page image data A with the name data generated in step SA2 and stores the data by writing it to the nonvolatile memory unit 220b (step SA3). Specifically, the control unit 200 writes the page image data A to an empty area of the nonvolatile memory unit 220b, and at the same time associates the name data with a starting address of the area where the page image data A is written or data expressing that starting address (e.g., an i-node number, etc.) and writes the name data and the starting address to a predetermined management file (e.g., a directory file or i-node list), thus storing that page image data. Note that while in the present operation example a case was described wherein the paper document to be digitized composes of one page, it is also possible for page image data corresponding to plural pages to be written to the empty area after being digitized, in cases where a paper document to be digitized includes plural pages.

As described above, with the document processing device 110 according to the present embodiment, page image data corresponding to pages in a paper document and name data corresponding to content of the paper document are associated and stored without a user performing any special operations. The document processing device 110 according to the present embodiment has the effect of reducing the burden on the user while making it possible to attach names to documents in accordance with their content and digitize them, when digitizing and saving paper documents.

### C. VARIATION EXAMPLES

The above was a detailed description of an embodiment of the present invention, but it is of course possible to add the variations described below.

### (C-1) First Variation Example

The embodiments above described a case wherein a single paper document is set in the ADF of the image reading device 120. However, it is also possible to set plural paper documents in the ADF, attach names corresponding to content of each of the plural paper documents, and digitize them. This is realized by letting the document processing device 110 detect boundaries between each paper document, and implement the paper document digitizing process (see FIG. 3) on page image data stored in the volatile memory unit 220a until a boundary is detected. Examples of methods for letting the document processing device 110 detect the document boundaries include a method for detecting document boundaries wherein a predetermined sheet which expresses a document boundary between documents (hereafter referred to as a “boundary sheet”) is inserted and document boundaries are detected based on an image on that boundary sheet, as well as a method for detecting document boundaries wherein a mark indicating a final page is attached to a margin on the last page of each document and document boundaries are detected by detecting an image corresponding to that mark.

### (C-2) Second Variation Example

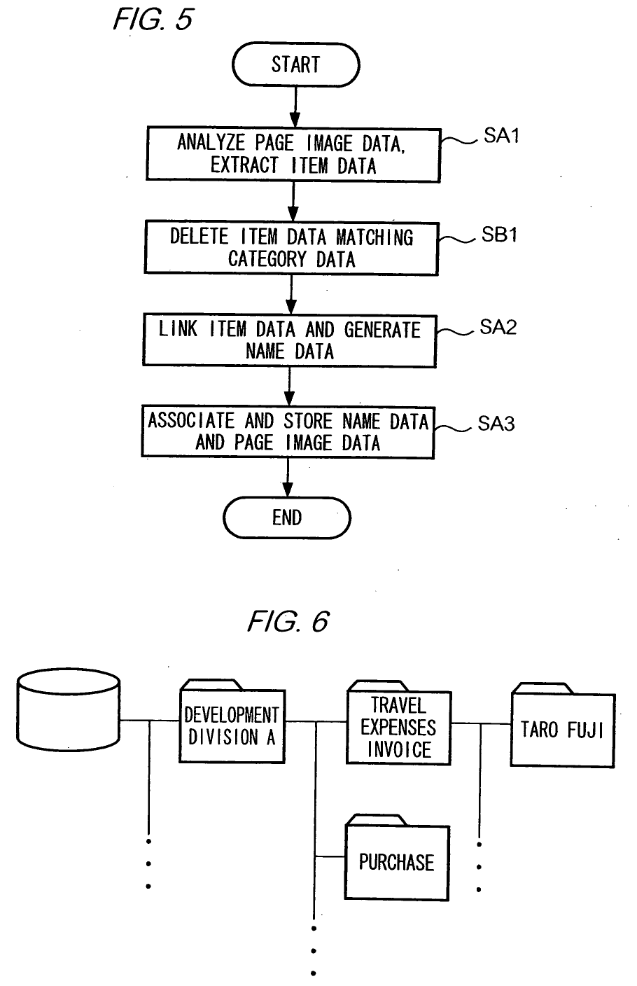

In the embodiment described above, a case was described wherein all item data obtained through analysis of page image data are linked and name data is generated which expresses the name attached to the page image data. However, it is also possible to generate the name data after excluding item data expressing content of items expressing the type of the document corresponding to the page image data (hereafter referred to as “category data”) from the item data obtained through analysis of the page image data. This is realized by storing the category data in a memory unit 220 beforehand, while at the same time letting the control unit 200 execute a paper document digitizing process shown in FIG. 5, instead of the paper document digitizing process shown in FIG. 3.

The paper document digitizing process shown in FIG. 5 differs from the paper document digitizing process shown in FIG. 3 in that a process in step SA2 is executed and name data is generated after item data which matches the category data is deleted in Step SB1 from the item data extracted in step SA1. To describe this in more detail, in step SB1 in FIG. 5, the control unit 200 determines for each of the item data extracted in step SA1 whether it matches the category data stored in the nonvolatile memory unit 220b and deletes item data that matches. This makes it possible to generate the name data after excluding item data which matches the category data.

The reason for generating the name data after excluding item data which matches the category data is as follows. Documents of the same type always include identical category data, so inclusion of this category data in the name data does not contribute to discriminating characteristics.

Furthermore, this kind of category data is generally used as folder names for performing relevant classification when classifying and accumulating documents by type as shown in FIG. 6, so including this kind of category data in the name data is redundant. This variation example has the effect of making it possible to exclude item data which does not contribute to discriminating characteristics between documents of the same type and generate non-redundant name data.

### (C-3) Third Variation Example

In the embodiment described above, a case was described wherein all item data obtained through analysis of page image data is linked and name data is generated which expresses the name attached to the page image data. However, since each OS is generally provided beforehand with an upper limit value regarding the number of characters (number of bytes) in names which can be attached to files, it is of course possible to determine beforehand the number of item data units to link when generating name data by linking the item data. More specifically, it is possible to determine an importance level for each item in documents, and generate the name data by linking only a predetermined number of the item data units obtained through analysis of page image data in ascending order or descending order of importance level. This is realized as described below.

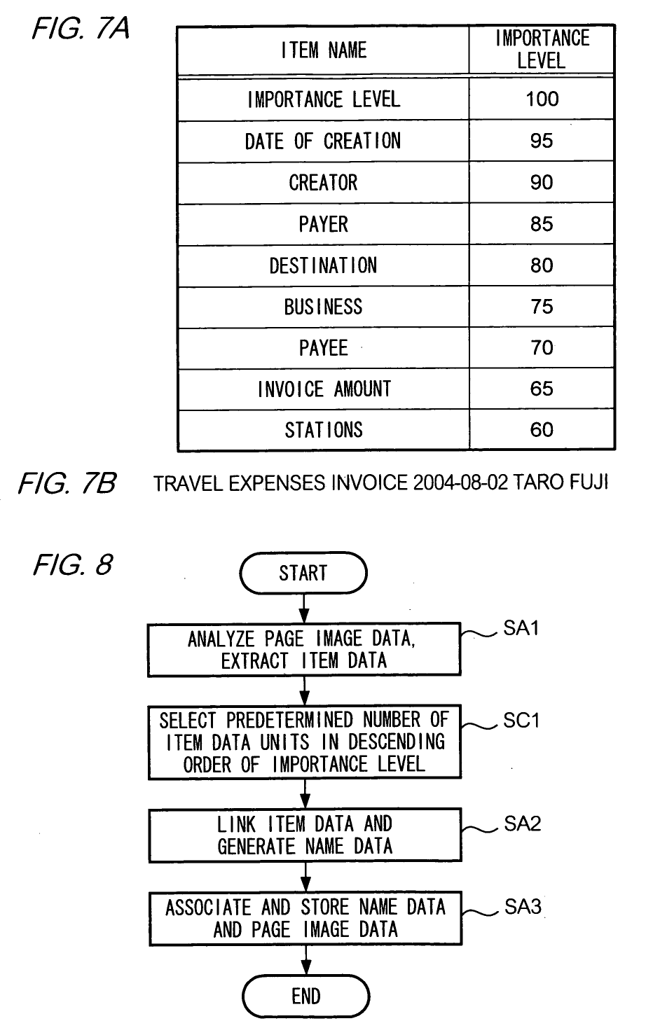

First, an importance level table shown in FIG. 7 is stored in the nonvolatile memory unit 220b of the document processing device. Importance level data which expresses importance levels for items in documents is stored in this importance level table for each item, and the higher an importance level data value is, the more important that item is. Note that in the present embodiment a case is described wherein one importance level table is stored beforehand in the nonvolatile memory unit 220b, but it is of course possible to store different importance level tables for different types of documents. One reason is that there might be different importance levels even for identical items in different types of documents.

If the control unit 200 is made to execute a paper document digitizing process shown in FIG. 8 instead of the paper document digitizing process shown in FIG. 3, generation of the name data is achieved by linking only a predetermined number of item data units obtained through analysis of page image data in descending order of importance level. The flowchart in FIG. 8 and the flowchart in FIG. 3 differ in that a step SC1 is provided for selecting only a predetermined number of item data units expressing content of items with high importance levels, from the item data extracted in step SA1, and name data is generated by linking in step SA2 described above the item data selected in the step SC1. To describe this in more detail, in step SC1 in FIG. 7, the control unit 200 specifies, for each of the item data units extracted in step SA1, the importance level of the item corresponding to that item data unit, referring to the content stored in the importance level table (see FIG. 7), and extracts only a predetermined number in order starting with the highest importance level. For instance, if the predetermined number is 3, then name data is generated by linking three item data units in order starting with the highest importance level, so if the item data shown in FIG. 4A has been extracted, then the name data shown in FIG. 7B is generated. Note that the present variation has been described with a case in mind wherein only a predetermined number of item data units extracted in step SA1 is extracted in order starting with the highest importance level of corresponding items, but it is of course possible to extract a predetermined number of item data units in order starting with the lowest importance level of corresponding items. Doing so makes it possible to generate name data linking only a predetermined number of item data units extracted in step SA1 above in order starting with the lowest importance level.

### (C-4) Fourth Variation Example

In the above embodiment, a case was described wherein page image data was not stored in advance in the nonvolatile memory unit 220b of the document processing device 110. However, it is of course possible to additionally write page image data to the nonvolatile memory unit 220b in which page image data is already written. However, in such a case, it is necessary to ensure that the names of the page image data already stored in the nonvolatile memory unit 220b are different from those of the newly stored page data, and this is achieved through modifying the document processing device described in the embodiment above as follows.

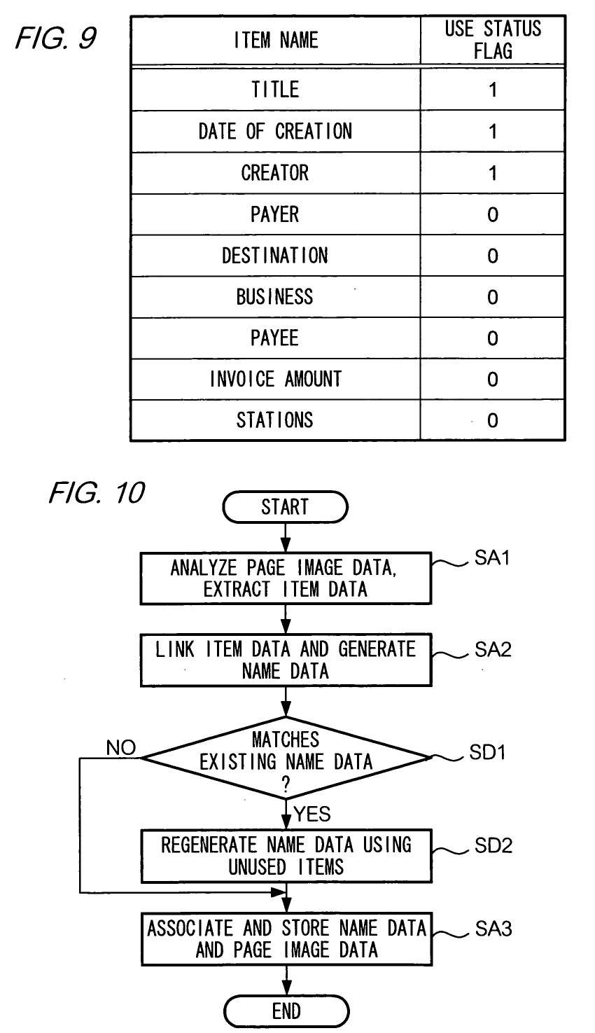

First, an item list table as shown in FIG. 9 is associated with each of the page image data and stored in the nonvolatile memory unit 220b. This item list table stores, in correspondence with data expressing the items in the document corresponding to the page image data corresponding to this item list table (for example a character string expressing the name of that item: referred to as “item identifier” below), data (e.g., flags having values of 0 or 1: hereafter referred to as use status flags) indicating whether the item data expressing the content of an item indicated by an item identifier has been used to generate name data. For example, in the item list table shown in FIG. 9, the item identifiers whose use status flag value is 0 indicate that the item data associated with the content of those item identifiers has not been used in generating name data. In other words, by referring to the stored contents in the item list table, it is possible to know which items or which content of those items in the document corresponding to page image data associated with the item list table has been reflected in the name of that page image data.

FIG. 10 is a flowchart showing a flow of a paper document digitizing process which is performed by the control unit 200 of the document processing device according to this variation. The paper document digitizing process shown in FIG. 10 differs from the paper document digitizing process shown in FIG. 3 in that a process (FIG. 10: step SD1) for judging whether name data generated in step SA2 matches name data already stored in the nonvolatile memory unit 220b, and a process (FIG. 10: step SD2) for regenerating name data generated in step SA2, when the judgment result in step SD1 was “Yes,” are performed.

To describe this in more detail, in step SD2 in FIG. 10, the control unit 200 refers to the item list table which is associated with the name data judged as matching in step SD1 and stored in the nonvolatile memory unit 220b, and specifies items which have not been used in generating that name data (hereafter referred to as “unused items”). Next, the control unit 200 generates name data again by linking only item data expressing content of the unused items, from among the item data extracted in step SA1. This makes it possible to avoid attaching identical names more often than once, even in cases where page image data is already stored in the nonvolatile memory unit 220b. Note that in the present variation example, a case was described wherein name data is regenerated using only item data corresponding to the unused items, but it is also possible to regenerate name data by adding item data corresponding to unused items to the generated name data, or to regenerate name data by replacing a portion of the item data used in generating that name data with a portion of item data corresponding to the unused items. In other words, anything is possible as long as name data is regenerated using item data corresponding to the unused items and name data is generated which is different from existing name data. In the present variation example, a case has been described wherein name data is regenerated expressing names to be attached to newly stored page image data, but it is also possible to update name data which is stored in the nonvolatile memory unit 220b (that is, name data expressing names attached to page image data already stored in the nonvolatile memory unit 220b).

### (C-5) Fifth Variation Example

In the embodiment described above, a case was described wherein software for making a control unit 200 realize functions specific to a document processing device according to the present invention is stored beforehand in the nonvolatile memory unit 220b. However, it is also of course possible to store the software in a storage medium which is readable by a computer, such as CD-ROM (Compact Disk—Read Only Memory) and DVD (Digital Versatile Disk), and install the software in a general computer device using this storage medium. This has the effect of making it possible to let a general computer device function as a document processing device according to the present invention.

As discussed above, the present invention provides a document processing device including: an inputting unit that inputs page image data corresponding to images of pages of a document; an extracting unit that analyzes the page image data input by the inputting unit, specifies the content of each item contained in the document corresponding to that page image data, and extracts item data, the item data being character strings expressing that content; a generating unit that links the item data extracted by the extracting unit and generates name data, the name data being a character string expressing a name to be attached to the document; and a writing unit that associates the name data generated by the generating unit with the page image data input by the inputting unit and writes the name data and the page image data to a memory.

With this document processing device, page image data corresponding to images of pages in a document and name data corresponding to the content of the document are associated with each other and written to the storage device.

According to another embodiment of the present invention, the document processing device further includes a category data memory that stores category data, the category data being character strings expressing document types, and the generating unit generates the name data, excluding item data that matches the category data stored in the category data memory from the item data extracted by the extracting unit. According to this embodiment, the name data is generated after excluding category data which is item data for items that are listed in common among documents of the same type and which are used when classifying these documents with other types of documents. This has the effect of making it possible to exclude from the name data the item data for items contained in common among documents of the same type, or in other words, to generate name data after excluding item data which lacks discriminating characteristics with respect to these documents of the same type.

According to another embodiment, the document processing device further includes: an importance data memory that stores importance level data which expresses an importance level for each item occurring in the document, and the generating unit specifies an importance level for each of the items corresponding to item data, according to the importance level data stored in the importance level data memory, and generates the name data by linking a predetermined number of the item data in descending order or ascending order of the importance level. According to this embodiment, name data is generated that reflects levels of importance for each of the items contained in the document. This has the effect of making it possible to know importance levels of content listed in the document corresponding to the page image data by referring to name data that is stored in association with the page image data, and also to prevent the data length of name data from growing.

According to another embodiment, the document processing device further includes: a name data memory that stores the name data generated by the generating unit for the document, and an item list listing items contained in each page of the documents, the name data and the item list being stored in association with page image data corresponding to pages of the document, if name data generated based on page image data input by the inputting unit matches other name data that is stored in the name data memory, the generating unit specifies, based on the item list, which is associated with the other name data and is stored in the name data memory, item data expressing content of unused items, which are those of the item data extracted by the extracting unit that have not been used when generating the other name data, and regenerates the name data using the item data corresponding to the unused items. This embodiment has the effect of making it possible to ensure that new page image data is stored to which name data is attached that is different from the name data attached to other documents whose page image data is already stored in the storing unit, or in other words, to avoid creating duplications in name data which is attached to documents.

According to another embodiment, the document processing device further includes: a name data memory that stores the name data generated by the generating unit for the document, and an item list listing items contained in each page of the documents, the name data and the item list being stored in association with page image data corresponding to pages of the document; a discriminating unit that discriminates whether name data generated by the generating unit is duplicate name data matching any of the name data stored in the name data memory; a specifying unit that, in case of name data which has been discriminated by the discriminating unit as being duplicate name data, specifies unused items, which are items that have not been used in generating the name data, based on the item list that is stored in the name data memory in association with that name data; and a rewriting unit that rewrites the name data that has been discriminated by the discriminating unit as being duplicate name data with new name data generated using the item data of the unused items specified by the specifying unit. This embodiment also has the effect of making it possible without fail to avoid creating duplications in name data attached to documents.

Also, the present invention provides a document processing method including: inputting page image data corresponding to images of pages of a document; analyzing the input page image data; specifying the content of each item contained in the document corresponding to the analyzed page image data; extracting item data which is character strings expressing the specified content; generating name data by linking the extracted item data, the name data being a character string expressing a name to be attached to the document; and writing to a first memory the generated name data generated and the input page image data in association with each other.

According to another embodiment, the document processing method further includes storing category data which is character strings expressing document types in a category data memory, and, when the name data is generated, item data matching the category data stored in the category data memory is not used.

According to another embodiment, the document processing method further includes storing importance level data in a importance level data memory, the importance level data expressing an importance level for each item occurring in the document, and, when the name data is generated, an importance level for each of the items corresponding to item data is specified according to the importance level data stored in the importance level data memory, and a predetermined number of the item data in descending order or ascending order of the importance level are linked.

According to another embodiment, the document processing method further includes storing in a name data memory the generated name data for the document and an item list listing items contained in each page of the documents, the name data and the item list being stored in association with page image data corresponding to pages of the document, and, if name data generated based on the input page image data matches other name data that is stored in the name data memory, item data is specified based on the item list, which is associated with the other name data and is stored in the name data memory, the item data being the extracted item data and expressing an item which has not been used when the other name data is generated, and the name data is regenerated using the item data corresponding to the unused items.

According to another embodiment, the document processing method further includes storing in a name data memory the generated name data for the document and an item list listing items contained in each page of the documents, the name data and the item list being stored in association with page image data corresponding to pages of the document; determining whether the generated name data is duplicate name data matching any of the name data stored in the name data memory; specifying, when it is determined that the name data is duplicate name data, unused items, which are items that have not been used when the name data is generated, based on the item list that is stored in the name data memory in association with the name data; and rewriting the name data that has been determined as being duplicate name data with new name data generated using the item data of the specified unused items.

Also, the present invention provides a computer-readable storage medium recording a program for causing a computer to perform a function, the function comprising: when page image data corresponding to images of pages in a document is input, analyzing that page image data, specifying the content of each item contained in the document corresponding to that page image data, and extracting item data, the item data being character strings expressing the content; linking the extracted item data and generating name data, the name data being a character string expressing a name to be attached to the document; and associating the generated name data with the page image data that has been input, and writing the name data and the page image data to a memory.

With this computer-readable storage medium, page image data corresponding to images of pages in a document and name data corresponding to content of the document are associated with each other and written to the storage device.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described to best explain the principles of the invention and its practical applications, to thereby enable others skilled in the art to understand various embodiments of the invention and various modifications thereof, to suit a particular contemplated use. It is intended that the scope of the invention be defined by the following claims and their equivalents.

What is claimed is:

1. A document processing device comprising:
an inputting unit that inputs page image data corresponding to images of pages of a document; an extracting unit that analyzes the page image data input by the inputting unit, specifies the content of each item contained in the document corresponding to that page image data, and extracts item data, the item data being character strings expressing that content;
a generating unit that links the item data extracted by the extracting unit and generates name data, the name data being a character string expressing a name to be attached to the document; and
a writing unit that associates the name data generated by the generating unit with the page image data input by the inputting unit and writes the name data and the page image data to a memory.

2. The document processing device according to claim 1, further comprising:
a category data memory that stores category data, the category data being character strings expressing document types;
wherein the generating unit generates the name data, excluding item data that matches the category data stored in the category data memory from the item data extracted by the extracting unit.

3. The document processing device according to claim 1 further comprising:
an importance level data memory that stores importance level data which expresses an importance level for each item occurring in the document;
wherein the generating unit specifies an importance level for each of the items corresponding to item data, according to the importance level data stored in the importance level data memory, and generates the name data by linking a predetermined number of the item data in descending order or ascending order of the importance level.

4. The document processing device according to claim 1 further comprising:
a name data memory that stores the name data generated by the generating unit for the document and an item list listing items contained in each page of the documents, the name data and the item list being stored in association with page image data corresponding to pages of the document;
wherein, if name data generated based on page image data input by the inputting unit matches other name data that is stored in the name data memory, the generating unit specifies, based on the item list, which is associated with the other name data and is stored in the name data memory, item data expressing content of unused items, which are those of the item data extracted by the extracting unit that have not been used when generating the other name data, and regenerates the name data using the item data corresponding to the unused items.

5. The document processing device according to claim 1 further comprising:
a name data memory that stores the name data generated by the generating unit for the document and an item list listing items contained in each page of the documents, the name data and the item list being stored in association with page image data corresponding to pages of the document;
a discriminating unit that discriminates whether name data generated by the generating unit is duplicate name data matching any of the name data stored in the name data memory;
a specifying unit that, in case of name data which has been discriminated by the discriminating unit as being duplicate name data, specifies unused items, which are items that have not been used in generating the name data, based on the item list that is stored in the name data memory in association with that name data; and
a rewriting unit that rewrites the name data that has been discriminated by the discriminating unit as being duplicate name data with new name data generated using the item data of the unused items specified by the specifying unit.

6. A document processing method comprising:
inputting page image data corresponding to images of pages of a document;
analyzing the input page image data;
specifying the content of each item contained in the document corresponding to the analyzed page image data;
extracting item data which is character strings expressing the specified content;
generating name data by linking the extracted item data, the name data being a character string expressing a name to be attached to the document; and
writing to a first memory the generated name data generated and the input page image data in association with each other.

7. The document processing method according to claim 6, further comprising:
storing category data which is character strings expressing document types in a category data memory;
wherein, when the name data is generated, item data matching the category data stored in the category data memory is not used.

8. The document processing method according to claim 6 further comprising:
storing importance level data in a importance level data memory, the importance level data expressing an importance level for each item occurring in the document;
wherein, when the name data is generated, an importance level for each of the items corresponding to item data is specified according to the importance level data stored in the importance level data memory, and a predetermined number of the item data in descending order or ascending order of the importance level are linked.

9. The document processing method according to claim 6 further comprising:
storing in a name data memory the generated name data for the document and an item list listing items contained in each page of the documents, the name data and the item list being stored in association with page image data corresponding to pages of the document;
wherein, if name data generated based on the input page image data matches other name data that is stored in the name data memory, item data is specified based on the item list, which is associated with the other name data and is stored in the name data memory, the item data being the extracted item data and expressing an item which has not been used when the other name data is generated, and the name data is regenerated using the item data corresponding to the unused items.

10. The document processing method according to claim 6 further comprising:
storing in a name data memory the generated name data for the document and an item list listing items contained in each page of the documents, the name data and the item list being stored in association with page image data corresponding to pages of the document;
determining whether the generated name data is duplicate name data matching any of the name data stored in the name data memory;
specifying, when it is determined that the name data is duplicate name data, unused items, which are items that have not been used when the name data is generated, based on the item list that is stored in the name data memory in association with the name data; and
rewriting the name data that has been determined as being duplicate name data with new name data generated using the item data of the specified unused items.

11. A computer-readable storage medium recording a program for causing a computer to perform a function, the function comprising:
when page image data corresponding to images of pages in a document is input, analyzing that page image data, specifying the content of each item contained in the document corresponding to that page image data, and extracting item data, the item data being character strings expressing the content;
linking the extracted item data and generating name data, the name data being a character string expressing a name to be attached to the document; and
associating the generated name data with the page image data that has been input, and writing the name data and the page image data to a memory.
